(19) United States
(12) Patent Application Publication
(10) Pub. No.: US 2012/0051985 A1
(43) Pub. Date: Mar. 1, 2012

(54) METHOD FOR MANUFACTURING LIQUID DROPLET MICROARRAYS, MICROARRAYS PREPARED BY USING THE SAME, A DEVICE FOR DELIVERING MATERIALS AND A METHOD FOR DELIVERING MATERIALS BY USING A DEVICE FOR DELIVERING MATERIALS COMPRISING THE SAME

(75) Inventors: Sin-Doo LEE, Seoul (KR); Sang-Wook LEE, Boryeong-si (KR); Seung Chul PARK, Seoul (KR)

(73) Assignee: SNU R&DB FOUNDATION, Seoul (KR)

(21) Appl. No.: 13/216,494

(22) Filed: Aug. 24, 2011

(30) Foreign Application Priority Data
Aug. 25, 2010 (KR) 10-2010-0082420

(51) Int. Cl. B01L 3/00; B23P 17/00

(52) U.S. Cl. 422/502; 29/890.1

(57) ABSTRACT

Provided is a method for manufacturing liquid droplet microarrays, including: providing a lower substrate on which microstructures are patterned; providing an upper substrate to which one or more liquid path lines and a liquid reservoir are linked at both sides thereof; placing the upper substrate over the lower substrate; and arranging liquid droplets in microarrays on the structures of the lower substrate by allowing a liquid contained in the liquid reservoir to flow though the liquid path lines. Provided also are liquid droplet microarrays obtained by the method, a device for delivering a material including the liquid droplet microarrays, and a method for delivering a material through the device.

### CROSS-REFERENCE TO RELATED APPLICATION

This application claims priority to Korean Patent Application No. 10-2010-0082420 filed on Aug. 25, 2010 in Korea, and all the benefits accruing therefrom under 35 U.S.C. §119, the contents of which in its entirety are herein incorporated by reference.

### BACKGROUND

1. Field

The following disclosure relates to a method for manufacturing liquid droplet microarrays, microarrays prepared by the same method, a device for delivering materials including the same microarrays, and a method for delivering materials by using the same device. More particularly, the following disclosure relates to a method for manufacturing liquid droplet microarrays by using liquid droplets remaining at the edges of microstructures due to a capillary phenomenon when allowing a liquid to flow on a substrate having microstructures patterned thereon. In addition, the following disclosure relates to microarrays prepared by arranging various materials contained in the liquid or present on the substrate in a micro-scale through the above method. Further, the following disclosure relates to a method for delivering different materials sequentially through a device for delivering materials including the above liquid droplet microarrays.

2. Description of Related Art

Recently, technologies for manufacturing liquid micro-scaled arrays (referred to also as microarrays hereinafter) containing various materials useful for a wide range of industrial fields have been spotlighted, since they are simple and cost-efficient. A wide range of materials may be applied to such technologies and particular examples thereof include not only polymers and nanoparticles but also DNA and cells for use in the fields of electronics, optics, chemistry and bioscience. Moreover, such technologies are valuable since they allow liquid droplets to be arranged uniformly on the whole surface of a substrate in a short time. Related art works suggest ink-jet printing or surface wetting processes to manufacture liquid droplet microarrays. Such processes are very effective for using materials remaining after the evaporation of a liquid arranged on a substrate.

However, when evaporating water containing cells or other biosubstances, such biosubstances lose their activities. Thus, the related art works are not suitable for such biosubstances. Under these circumstances, some attempts have been made to carry out the processes in a humidity conditioner or on a substrate containing water. However, there exist several problems, including high cost or low resolution.

Other processes include a process for manufacturing microarrays by forming water droplets in flowing oil by using surface energy at the boundary surfaces of microchannels in which oil and water are immiscible with each other. Although the above process does not allow evaporation of water droplets and shows relatively high resolution, it is disadvantageous in that other materials may not be delivered to biosubstances because the biosubstances contained in the arranged water droplets are isolated by oil.

It is expected that technologies capable of manufacturing microarrays of a liquid containing various kinds of materials with high resolution, preventing evaporation of water containing biosubstances, and delivering other materials sequentially to the arranged materials may be utilized effectively in various industrial fields. Particularly, such technologies may be utilized in electronic devices, including organic light emitting diodes realized by stacking materials in the form of layers. In addition, since microarrays using biosubstances and delivery of reagents may be carried out in a small chip, it is expected that such technologies serve as a key to the so-called lab-on-a-chip in the future. However, there have been no technologies satisfying such arrangement and evaporation conditions.

### SUMMARY

An embodiment of the present invention is directed to providing a method for manufacturing liquid droplet microarrays.

Another embodiment of the present invention is directed to providing a method for manufacturing microarrays of different materials by allowing a liquid provided to microarrays to flow with a material incorporated thereto.

Still another embodiment of the present invention is directed to providing a device for delivering a new material to microarrays of different materials obtained through liquid droplet microarrays, and a method for delivering a new material by using the same.

In one general aspect, there is provided a method for manufacturing liquid droplet microarrays, including: providing a lower substrate on which microstructures are patterned; providing an upper substrate to which one or more liquid path lines and a liquid reservoir are linked at both sides thereof; placing the upper substrate over the lower substrate; and arranging liquid droplets in microarrays on the structures of the lower substrate by allowing a liquid contained in the liquid reservoir to flow though the liquid path lines.

The liquid may be any type of liquid. There is no particular limitation in the liquid as long as it may be applicable to the manufacture of liquid droplet microarrays disclosed herein. Particular examples of the liquid include a liquid, such as water, volatile or non-volatile organic solvent or buffer, a mixture thereof, or a complex fluid such as liquid crystals. In addition, particular examples of the organic solvent include ethanol, benzene or chloroform, and those of the buffer include phosphate buffer, Tris buffer or acetate buffer.

In one embodiment, the liquid droplets may be controlled in their shapes by adjusting the size or distance of the structures patterned on the lower substrate. Specifically, the adjacent liquid droplets in the liquid droplet microarrays may be connected with each other or not.

In another embodiment, the structures of the lower substrate may have a channel-like shape, or a shape protruding upwardly or downwardly. For example, the structures may be patterned in a well-like shape, but are not limited thereto.

In addition, the structures of the lower substrate may be patterned with various sizes according to the meniscus length of the liquid from the boundary of the microstructures of the lower substrate to the bottom of the structures.

Optionally, the method may further include, after arranging the liquid droplets in microarrays, piercing the liquid path lines so that they may be communicated with the external air, thereby evaporating the liquid droplets, or replenishing a liquid to the liquid path lines and liquid reservoir so that the liquid droplets may not be evaporated but retained.

In addition, the operation of arranging the liquid droplets in microarrays on the structures of the lower substrate may be carried out by allowing the liquid containing a material to flow through the liquid path lines of the upper substrate, thereby providing the microarrays of the liquid containing the material on the structures of the lower substrate. In this manner, it is possible to obtain microarrays of the material arranged through the liquid droplets.

The material contained in the liquid may be any material capable of being dispersed in the liquid. Particular examples of the material include nanoparticles or biosubstances, more specifically lipid bilayers or red blood cells, proteins, DNA or cells. The material may include two or more different materials.

In one embodiment, the liquid droplets and the material may be controlled in arrangement by adjusting the size and distance of the structures patterned on the lower substrate.

In addition, the operation of arranging the liquid droplets in microarrays on the structures of the lower substrate may include: allowing the liquid containing a material to flow through the liquid path lines, thereby providing the microarrays of the liquid containing the material on the structures of the lower substrate; and allowing an additional amount of the liquid to flow through the liquid path lines, thereby providing microarrays containing one or more materials inside the structures of the lower substrate while preventing the materials from remaining in the exterior of the structures. In this manner, it is possible to provide microarrays of a liquid containing one or more materials.

In one embodiment, the material contained in the microstructures of the lower substrate may include a material separated from the lower substrate upon the exposure to air.

In another embodiment, the material contained in the structures of the lower substrate may include two or more materials having a first material separated from the lower substrate upon the exposure to air and disposed on a lower layer, and a second material disposed over the first material.

Further, the operation of arranging the liquid droplets in microarrays on the structures of the lower substrate may include: distributing one or more materials uniformly on the lower substrate; and allowing a liquid to flow through the liquid path lines of the upper substrate, thereby providing microarrays containing one or more materials inside the structures of the lower substrate while preventing the materials from remaining in the exterior of the structures. In this manner, it is possible to obtain liquid droplet microarrays containing one or more materials.

In one embodiment, the materials contained in the microstructures of the lower substrate may include a material separated from the lower substrate upon the exposure to air.

In another embodiment, the materials contained in the structures of the lower substrate may include two or more materials having a first material separated from the lower substrate upon the exposure to air and disposed on a lower layer, and a second material disposed over the first material.

In another general aspect, there is provided liquid droplet microarrays prepared by the above-described method.

In still another general aspect, there is provided a device for delivering a material including the liquid droplet microarrays.

In yet another general aspect, there is provided a method for delivering a material through the device for delivering a material, the method including: injecting a liquid containing a material to be delivered to the device so that the material may be delivered to the liquid droplet microarrays included in the device.

More particularly, the liquid containing the material to be delivered may be injected to the liquid reservoir of the upper substrate so that it may be delivered to the microarrays.

### BRIEF DESCRIPTION OF THE DRAWINGS

FIG. 1A and FIG. 1B are schematic views showing the process diagram of the method for manufacturing liquid droplet microarrays according to one embodiment, wherein FIG. 1A shows that the boundary surface between air and the liquid moves from one liquid path line of a device obtained by causing an upper substrate having two liquid path lines linked at both sides thereof to be in contact with a lower substrate toward the other liquid path line of the device, while allowing liquid droplets to remain at the boundary of microstructures, and FIG. 1B shows liquid droplet microarrays obtained after the boundary surface between air and the liquid flows out completely.

FIG. 2A is an electron microscopic image of a lower substrate on which microstructures are patterned to be used in the method for manufacturing liquid droplet microarrays according to one embodiment. FIG. 2B is an electron microscopic image of a lower substrate having rectangular well-shaped structures used for manufacturing liquid droplet microarrays, for manufacturing liquid droplet microarrays containing a material and for delivering a different material.

FIG. 3A is an optical microscopic image of liquid droplet microarrays formed on the microstructures of the lower substrate, after completing the process as shown in FIG. 1 in a system using the lower substrate as shown in FIG. 2A according to one embodiment. FIG. 3b is an optical microscopic image of liquid droplet microarrays formed on the rectangular well-shaped structures, after completing the process as shown in FIG. 1 in a system using the lower substrate as shown in FIG. 2B according to one embodiment.

FIG. 4A is a process diagram showing a method for manufacturing microarrays of a liquid and an organic material through the process as shown in FIG. 1 by allowing the liquid containing the organic material to flow through a system obtained by using the lower substrate as shown in FIG. 2B according to one embodiment. FIG. 4B is a fluorescence microscopic image showing the microarrays of the liquid and the material contained therein, obtained from the method as shown in FIG. 4A.

FIG. 5A shows a process diagram and a fluorescence microscopic image of a material according to an embodiment, wherein the process diagram illustrates a method for manufacturing microarrays of a liquid and a material by allowing the material preliminarily formed on the lower substrate in the system obtained by using the lower substrate as shown in FIG. 2B to remain inside the structures of the lower substrate through the process as shown in FIG. 1, while the materials outside the structures are detached. FIG. 5B is a fluorescence microscopic image showing the material and liquid droplet microarrays on the lower substrate, obtained by the method as shown in FIG. 5A.

FIG. 6A is a process showing a method for manufacturing liquid droplet microarrays containing a liquid and two or more materials at the same time by allowing the two or more materials preliminarily formed on the lower substrate in the system obtained by using the lower substrate as shown in FIG. 2B to remain inside the structures of the lower substrate through the process as shown in FIG. 1, while the material outside the structures is detached. FIG. 6B is a photograph of a fluorescence microscopic image combined with an optical microscopic image, showing the liquid droplet microarrays containing the two materials on the lower substrate, obtained by the method as shown in FIG. 6A.

FIG. 7A is a schematic view showing that a third material may be delivered through one liquid path line of the upper substrate in the liquid droplet microarrays containing the materials obtained by the process as shown in FIG. 6 in a system obtained by using the lower substrate as shown in FIG. 2B, in accordance with an embodiment. FIG. 7B is an optical microscopic image taken when observing reaction of the existing materials caused by the material delivered as shown in FIG. 7A.

### DETAILED DESCRIPTION

Exemplary embodiments now will be described more fully hereinafter with reference to the accompanying drawings, in which exemplary embodiments are shown. The present disclosure may, however, should not be construed as limited to the exemplary embodiments set forth therein.

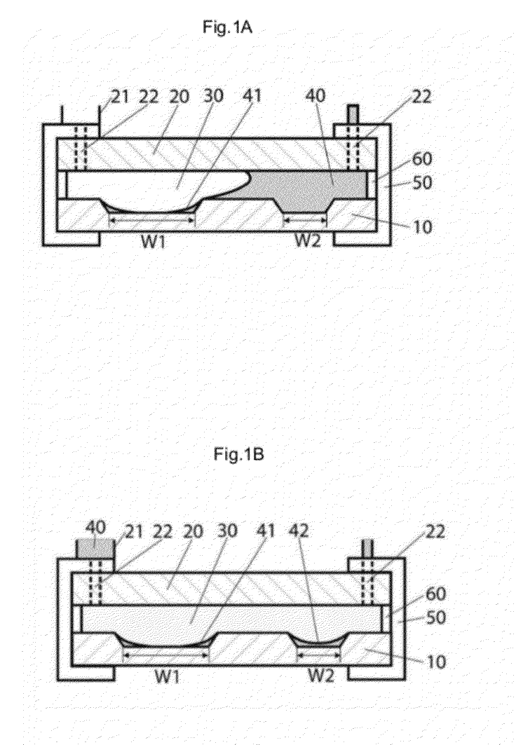

FIG. 1A and FIG. 1B are schematic views showing the process diagram of the method for manufacturing liquid droplet microarrays according to one embodiment. FIG. 1A shows that the boundary surface between air and the liquid moves from one liquid path line of a device obtained by causing an upper substrate having two liquid path lines linked at both sides thereof to be in contact with a lower substrate toward the other liquid path line of the device, while allowing liquid droplets to remain at the boundary of microstructures, and FIG. 1B shows liquid droplet microarrays obtained after the boundary surface between air and the liquid flows out completely.

Referring to FIG. 1A, an upper substrate 20 to which two liquid path lines 22 and one liquid reservoir 21 are linked is allowed to be in contact with a lower substrate 10 patterned with structures by using a spacer 60 providing a predetermined distance between the upper substrate and the lower substrate, and the resultant system is treated with a waterproof film 50. Herein, the lower substrate 10 has one or more structures for retaining liquid droplets, wherein the structures have a channel-like shape or a shape protruding downwardly or upwardly. The upper substrate 20 may be flat or may be patterned with structures to control the flow of a liquid.

There is no particular limitation in size or depth of the patterned structures as long as the structures may be used in microarrays. For example, the structures may have a length of about 5-500 μm and a depth of about 1-25 μm.

After the system including the lower substrate 10 and the upper substrate 20 in contact with each other is finished, a small amount of liquid is introduced into the liquid reservoir. Then, the liquid is allowed to be introduced into and to flow through one liquid path line so that it is transferred totally to the other liquid path line. While air is injected to the system, an interface 41 between air 30 and the liquid 40 flows toward the other liquid path line. Herein, the liquid 40 may include any kinds of liquids and complex fluids and particular examples thereof are as described hereinabove.

Referring to FIG. 1B, while the interface 41 between air 30 and the liquid 40 flows, it contacts with the structures of the lower substrate 10 so that liquid droplets may be left at the boundary of the structures due to a capillary phenomenon. In this manner, liquid droplets are arranged in microarrays in a plurality of structures.

Based on this, different types of liquid droplet microarrays may be obtained depending on the distance between the adjacent structures of the lower substrate 10. For example, liquid droplets 41 having a form in which the adjacent liquid menisci are separated from each other are formed at large structures W1, while liquid droplets 42 having a form in which the adjacent liquid menisci are connected with each other are formed at small structures W2.

The large structures W1 or the small structures W2 may have a different size or depth depending on the height of the structures, type of the liquid or surface energy of the substrate. For example, when the structures have a height of 2 μm, W1 may be 100 μm or more and W2 may be 50 μm or less.

When the manufacture of the liquid droplet microarrays is finished, the liquid reservoir 21 is filled with liquid 40 in order to prevent evaporation of the resultant liquid droplet microarrays. On the other hand, when the liquid reservoir 21 and the liquid path lines are opened to be communicated with the external air, the liquid droplet microarrays may be evaporated.

Meanwhile, the lower substrate 10 may be obtained by a physicochemical patterning method on a substrate made of various kinds of materials. In the embodiment, the lower substrate is obtained by etching a portion of quartz wafer (crystal orientation (100)) through a photolithographic process.

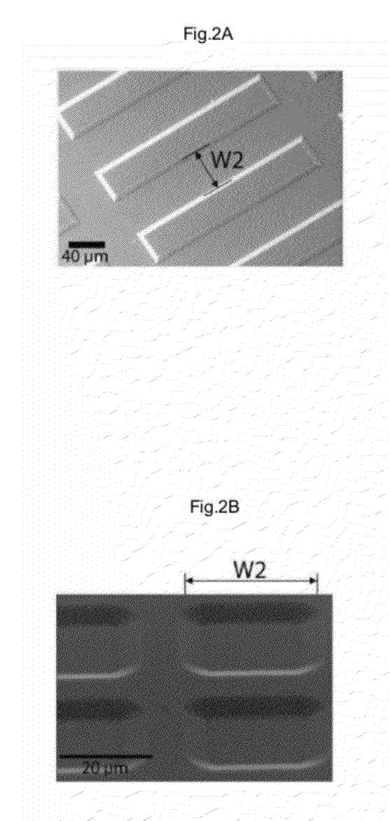

FIG. 2A and FIG. 2B are electron microscopic images of a lower substrate on which structures are patterned in accordance with an embodiment. FIG. 2A is an electron microscopic image of a lower substrate having small structures W2 patterned in such a manner that the structures protrude upwardly. FIG. 2B is an electron microscopic image of a lower substrate having small structures W2 patterned in such a manner that the structures protrude downwardly.

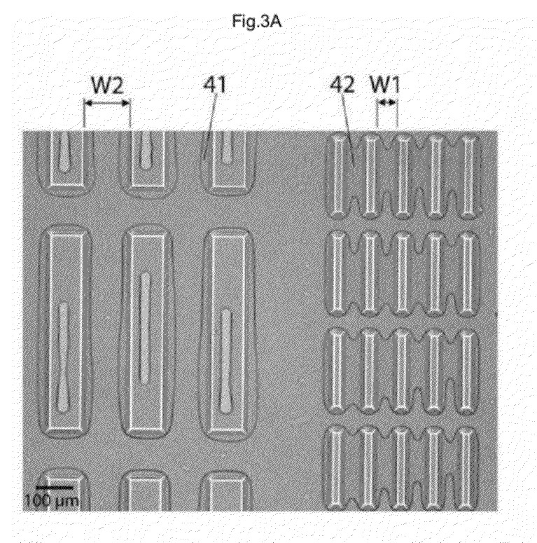

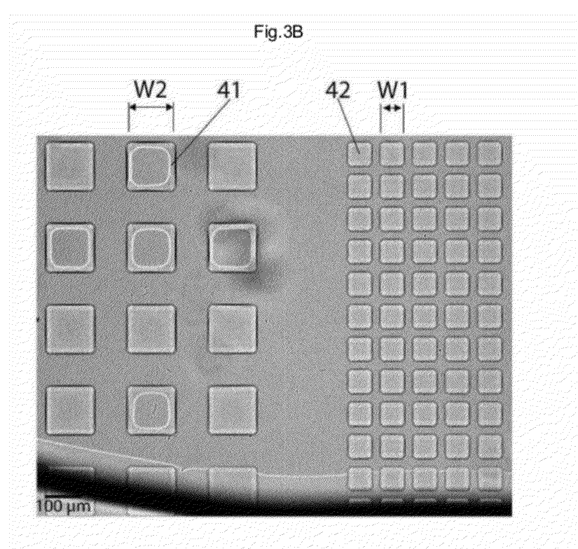

FIG. 3A and FIG. 3b are optical microscopic images taken after completing the process as shown in FIG. 1 by injecting water to the lower substrate obtained as shown in FIG. 2 in accordance with an embodiment. The embodiments using water as shown in FIG. 3A and FIG. 3b are for illustrative purposes only, and any kinds of liquids and complex liquids such as liquid crystals may be applied to the method for manufacturing liquid droplet microarrays disclosed herein. Particular examples of the liquid are as described hereinabove.

Referring to FIG. 3A showing liquid droplet microarrays, water menisci 41 are separated from each other in the large structures W2 protruding upwardly, while water menisci 42 are connected with each other in the small structures W1.

Referring to FIG. 3b showing liquid droplet microarrays, water menisci 41 are separated from each other in the large structures W2 protruding downwardly so that the bottoms of the structures are exposed, while water menisci 42 are connected with each other in the small structures W1 so that the structures are filled with water.

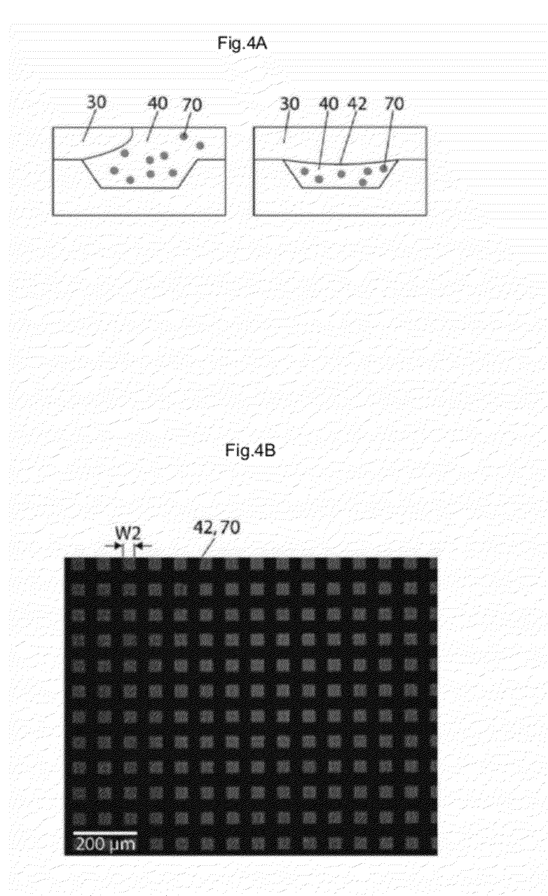

FIG. 4A is a process diagram showing a method for manufacturing microarrays of various materials through the method for manufacturing liquid droplet microarrays according to one embodiment. A liquid 40 in which various materials 70 are dispersed is injected to the system obtained by using a lower substrate having small structures protruding downwardly. Then, when the interface between air 30 and the liquid 40 is in contact with the structures, the materials remain inside the structures along with the liquid. In this manner, it is possible to obtain microarrays of the materials.

FIG. 4B is a fluorescence microscopic image showing the microarrays of pentacene molecules dissolved in chlorobenzene, taken after completing the process of FIG. 4A by using the lower substrate having the structures protruding downwardly. Such selection of the liquid and the dispersed material is for illustrative purpose only, and any kinds of liquids and materials may be applied to the method for manufacturing liquid droplet microarrays disclosed herein.

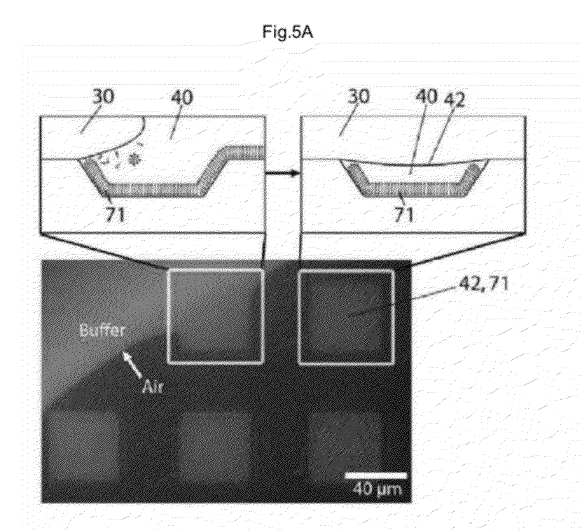

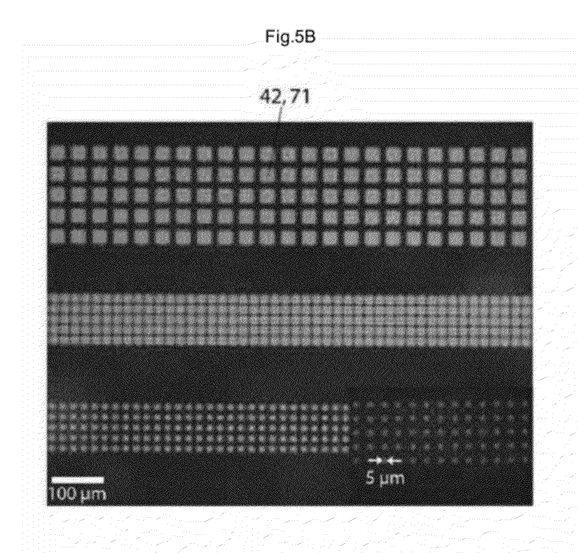

FIG. 5A show a process diagram illustrating a method for manufacturing liquid droplet microarrays of various materials according to an embodiment, and a fluorescence microscopic image of the liquid droplet microarrays. A material 71 is placed first on the lower substrate having small structures protruding downwardly, and a liquid 40 is injected. When the interface between air 30 and the liquid 40 is in contact with the structures, the material 71, which, otherwise, is distributed uniformly, remains only inside the structures and is detached from the outside of the structures. In this manner, microarrays of the material are obtained. As the material 71, a lipid bilayer is used and a buffer having an adjusted ion concentration in water is used as the liquid. Such selection of the material and the liquid is for illustrative purpose only. Any material may be applied to the method for manufacturing liquid droplet microarrays disclosed herein, as long as it is detached from the substrate upon the exposure to the liquid and air.

FIG. 5B is a fluorescence microscopic image of the microarrays of buffer 42 containing the lipid bilayer 71, after completing the process as shown in FIG. 5A on the lower substrate having small structures protruding downwardly. Although resolution reaches up to several micrometers in this embodiment, it may reach up to a nanometer scale on the basis of the same principle.

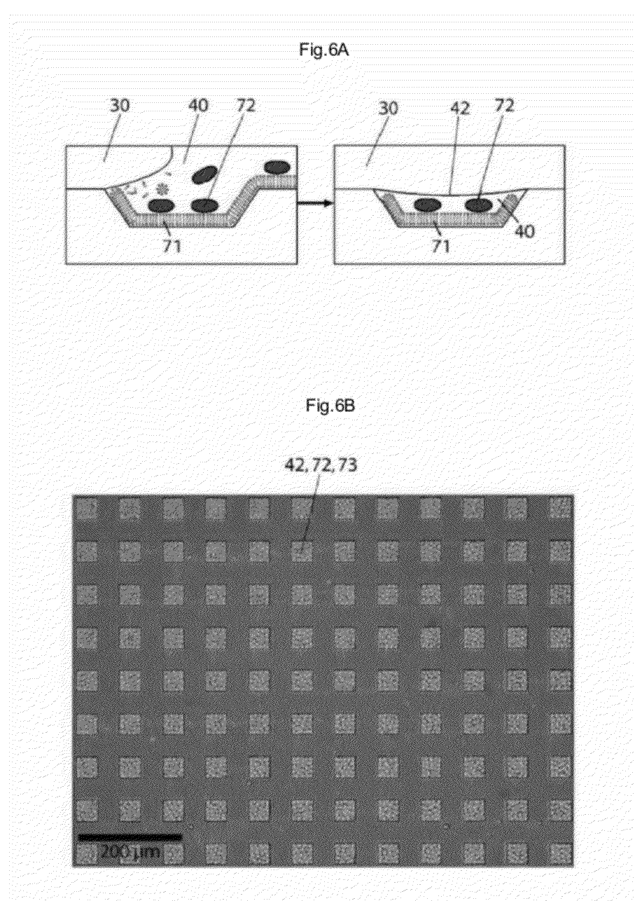

FIG. 6A is a process diagram showing a method for manufacturing microarrays of two or more different materials by using the liquid droplet microarrays according to an embodiment. Two or more materials 71, 72 are placed first on the lower substrate having small structures protruding downwardly, and a liquid 40 is injected. When the interface between air 30 and the liquid 40 is in contact with the structures, the materials 71, 72, which, otherwise, are distributed uniformly, remain only inside the structures and are detached from the outside of the structures. In this manner, microarrays of the two or more materials are obtained. As the lower material 71, a lipid bilayer and red blood cells are used and a buffer having an adjusted ion concentration in water is used as the liquid. Such selection of the materials and the liquid is for illustrative purpose only. When using a material detached from the substrate upon the exposure to air and various liquids as the lower layer material 71, any material may be applied to the method for manufacturing liquid droplet microarrays disclosed herein as the upper layer material 72.

FIG. 6B is a photograph of a fluorescence microscopic image combined with an optical microscopic image, showing the liquid droplet microarrays of the buffer 42 containing the lipid bilayer 71 and red blood cells 72, after completing the process as shown in FIG. 6A on the lower substrate having small structures protruding downwardly. Although resolution reaches up to several micrometers in this embodiment, it may reach up to a nanometer scale on the basis of the same principle.

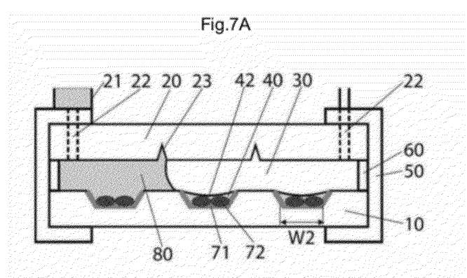

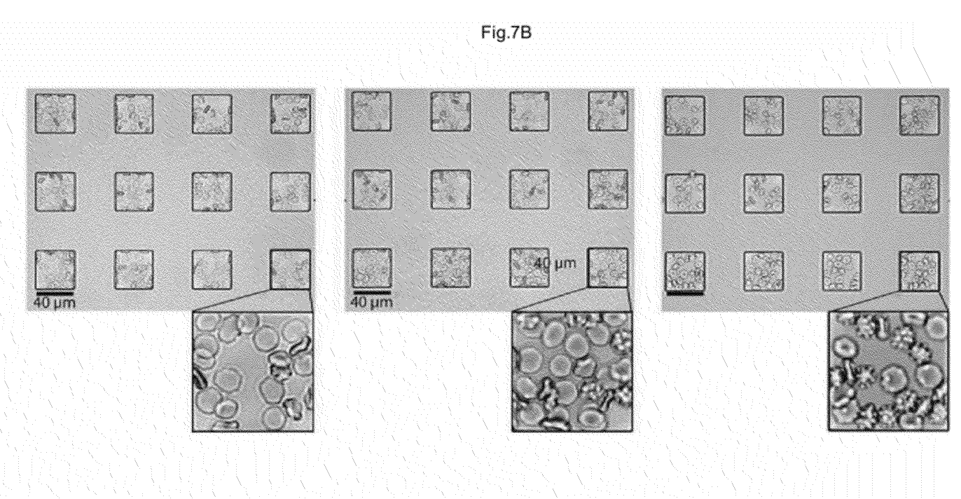

FIG. 7A is a schematic view showing a method for delivering a third material to the microarrays containing two or more materials, after manufacturing the microarrays by using the method for manufacturing liquid droplet microarrays in accordance with an embodiment. Two or more materials 71, 72 are placed first on the lower substrate 10 having small structures W2 protruding downwardly, and a liquid 40 is injected. When the interface between air 30 and the liquid 40 is in contact with the structures, the materials 71, 72, which, otherwise, are distributed uniformly, remain only inside the structures and are detached from the outside of the structures. In this manner, microarrays of the materials are obtained. At that time, another liquid 80 containing a third material is injected through the liquid reservoir 21 and the liquid path line 22 so that it may be delivered to the existing microarrays of the two or more materials. A flow-controlling structure 23 may be patterned on the upper substrate 20 in order to control the flow of the liquid 80. As the lower material 71, a lipid bilayer and red blood cells are used and a buffer having an adjusted ion concentration in water is used as the liquid. As the liquid 80, a mixture of water with ethanol is used. Such selection of the materials and the liquids is for illustrative purpose only. When using, as the lower layer material 71, a material detached from the substrate upon the exposure to air, various types of liquids 40 and the liquid 80 containing various materials, any material may be applied to the method for delivering a third material to the microarrays of two or more materials as the upper layer material 72, after manufacturing the microarrays according to the method for manufacturing liquid droplet microarrays disclosed herein.

FIG. 7B is an optical microscopic image of the microarrays of the lipid bilayer 71 and red blood cells 72 reacted with another liquid delivered to the buffer 42 containing the lipid bilayer and red blood cells, after completing the process as shown in FIG. 7A on the lower substrate having small structures protruding downwardly.

Many modifications can be made by those skilled in the art to adapt a particular situation or material to the teachings of this disclosure without departing from the essential scope thereof.

As can be seen from the foregoing, the method disclosed herein allows manufacture of uniform liquid droplet microarrays regardless of the particular type of liquid. Therefore, it is possible to manufacture liquid droplet microarrays containing various materials. It is also possible to deliver a third material to the resultant microarrays.

What is claimed is:

1. A method for manufacturing liquid droplet microarrays, comprising:
providing a lower substrate on which microstructures are patterned;
providing an upper substrate to which one or more liquid path lines and a liquid reservoir are linked at both sides thereof;
placing the upper substrate over the lower substrate; and
arranging liquid droplets in microarrays on the structures of the lower substrate by allowing a liquid contained in the liquid reservoir to flow though the liquid path lines.

2. The method according to claim 1, wherein the structures patterned on the lower substrate are controlled in their sizes and distances to control shapes of the liquid droplets.

3. The method according to claim 1, wherein the structures of the lower substrate have a channel shape, or a shape protruding upwardly or downwardly.

4. The method according to claim 1, which further comprises evaporating the liquid droplets, after said arranging the liquid droplets in microarrays on the structures of the lower substrate.

5. The method according to claim 1, which further comprises supplementing the liquid path lines and the liquid reservoir with the liquid so that the liquid droplets are not evaporated but retained, after said arranging the liquid droplets in microarrays on the structures of the lower substrate.

6. The method according to claim 1, wherein said arranging the liquid droplets in microarrays on the structures of the lower substrate is carried out by allowing the liquid containing a material to flow through the liquid path lines of the upper substrate so that the microarrays of the liquid containing the material are formed on the structures of the lower substrate.

7. The method according to claim 1, wherein said arranging the liquid droplets in microarrays on the structures of the lower substrate comprises: allowing the liquid containing a material to flow through the liquid path lines of the upper substrate so that the microarrays of the liquid containing the material are formed on the structures of the lower substrate; and further allowing the liquid containing a material to flow through the liquid path lines so that microarrays containing one or more materials are formed inside the structures of the lower substrate, while preventing the materials from remaining outside of the structures, thereby providing microarrays of liquid containing one or more materials.

8. The method according to claim 6, wherein the materials contained inside the structures of the lower substrate comprise a first material separated from the substrate upon exposure to air.

9. The method according to claim 6, wherein the materials contained inside the structures of the lower substrate comprise two or more materials, and a first material separated from the substrate upon exposure to air is positioned in a lower layer and a second material is placed over the first material.

10. The method according to claim 1, wherein said arranging the liquid droplets in microarrays on the structures of the lower substrate comprises:
distributing one or more materials uniformly on the lower substrate; and allowing a liquid to flow through the liquid path lines of the upper substrate so that the microarrays of the liquid containing one or more materials are formed inside the structures of the lower substrate, while preventing the materials from remaining outside of the structures, thereby providing liquid droplet microarrays containing one or more materials.

11. The method according to claim 10, wherein the materials contained inside the structures of the lower substrate comprise a material separated from the lower substrate upon exposure to air.

12. The method according to claim 10, wherein the materials contained inside the structures of the lower substrate comprise two or more materials, and a first material separated from the lower substrate upon exposure to air is positioned in a lower layer and a second material is placed over the first material.

13. Liquid droplet microarrays obtained by the method in accordance with claim 1.

14. A device for delivering a material comprising the liquid droplet microarrays in accordance with claim 13.

15. A method for delivering a third material through the device in accordance with claim 14, which comprises injecting a liquid containing a third material to be delivered to the device so that the third material is delivered to the liquid droplet microarrays provided in the device.
